(19) United States
(12) Patent Application Publication
(10) Pub. No.: US 2021/0022178 A1
(43) Pub. Date: Jan. 21, 2021

(54) COORDINATED ACCESS POINT (CAP) TRANSMISSIONS TO A SINGLE USER

(71) Applicant: QUALCOMM Incorporated, San Diego, CA (US)

(72) Inventors: Lochan VERMA, San Diego, CA (US); George CHERIAN, San Diego, CA (US); Alfred ASTERJADHI, San Diego, CA (US); Abhishek Pramod PATIL, San Diego, CA (US); Sai Yiu Duncan HO, San Diego, CA (US)

(21) Appl. No.: 16/924,891

(22) Filed: Jul. 9, 2020

Related U.S. Application Data
(60) Provisional application No. 62/874,571, filed on Jul. 16, 2019.

(51) Int. Cl. H04W 74/08; H04W 72/12; H04W 72/04; H04B 17/318

(52) U.S. Cl. CPC H04W 74/0808; H04W 72/1263; H04B 17/318; H04W 72/046; H04W 72/0453

(57) ABSTRACT

Certain aspects of the present disclosure provide techniques that may allow multiple access points (APs) to coordinate to send simultaneous OFDMA transmissions to a single user (SU). A set of APs participating in such a coordinated effort may be referred to as a coordinated AP (CAP) set. Hence, the transmissions according to this scheme may be referred to as CAP SU OFDMA transmissions.

### CROSS REFERENCE TO RELATED APPLICATION

This application hereby claims priority under 35 U.S.C. § 119 to pending U.S. Provisional Patent Application No. 62/874,571, filed on Jul. 16, 2019, the contents of which are incorporated herein in their entirety.

### FIELD OF DISCLOSURE

Certain aspects of the present disclosure generally relate to wireless communications and, more particularly, coordinated transmissions from multiple access points (APs) to a single station.

### DESCRIPTION OF RELATED ART

In order to address the issue of increasing bandwidth requirements demanded for wireless communication systems, different schemes are being developed to allow multiple user terminals to communicate with a single access point by sharing the channel resources while achieving high data throughputs. Wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

These multiple access technologies have been adopted in various telecommunication standards to provide a common protocol that enables different wireless devices to communicate on a municipal, national, regional, and even global level. NR (e.g., new radio or 5G) is an example of an emerging telecommunication standard. NR is a set of enhancements to the LTE mobile standard promulgated by 3GPP. NR is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, NR supports beamforming, multiple-input multiple-output (MIMO) antenna technology, and carrier aggregation.

Certain applications, such as virtual reality (VR), augmented reality (AR), and wireless video transmission may demand data rates, for example, in the range of several Gigabits per second. Certain wireless communications standards, such as the Institute of Electrical and Electronics Engineers (IEEE) 802.11 standard, denotes a set of Wireless Local Area Network (WLAN) air interface standards developed by the IEEE 802.11 committee for short-range communications (e.g., tens of meters to a few hundred meters).

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include secure transmission of video data between wireless nodes in a wireless network.

Certain aspects of the present disclosure provide a method of wireless communications by a first access point (e.g., that owns a transmit opportunity-TXOP). The method generally includes providing to one or more second APs of a set of APs that includes the first AP, an indication of orthogonal frequency resources allocated to each of the second APs for participating in parallel transmissions of data frames to a station within a transmit opportunity in which the first AP has gained access to a wireless medium, and outputting, during the transmit opportunity, a first data frame of the data frames for transmission to the station.

Certain aspects of the present disclosure provide a method of wireless communications by a first access point (e.g., participating in orthogonal frequency division multiple access-OFDMA transmission to a single user). The method generally includes obtaining, from a second AP of a set of APs that includes the first AP, an indication of orthogonal frequency resources allocated to the first AP for participating in parallel transmissions of data frames to a station within a transmit opportunity in which the second AP has gained access to a wireless medium, and outputting, during the transmit opportunity, a first data frame of the data frames for transmission to the station.

Certain aspects of the present disclosure provide a method of wireless communications by a station. The method generally includes associating with a set of access points (APs), determining APs of the set that are being scheduled to participate in parallel transmissions of data frames to the station within a transmit opportunity, determining orthogonal frequency resources allocated to each of the participating APs for the parallel transmissions, and obtaining one or more of the data frames on the orthogonal frequency resources within the transmit opportunity.

Aspects of the present disclosure also provide various apparatus, means, and computer program products corresponding to the methods and operations described above.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a diagram of an example wireless communications network, in accordance with certain aspects of the present disclosure.

FIG. 2 is a block diagram of an example access point and example user terminals, in accordance with certain aspects of the present disclosure.

FIG. 3 illustrates an example coordinated access point (CAP) downlink orthogonal frequency division multiple access (OFDMA) sequence, in accordance with certain aspects of the present disclosure.

FIG. 4 illustrates example operations for wireless communications by an access point (e.g., a TXOP owner), in accordance with certain aspects of the present disclosure.

FIG. 5 illustrates example operations for wireless communications by an access point (e.g., participating in CAP DL OFDMA transmissions to a single user), in accordance with certain aspects of the present disclosure.

FIG. 6 illustrates example operations for wireless communications by a station, in accordance with certain aspects of the present disclosure.

FIG. 7 illustrates an example resource allocation phase for CAP DL OFDMA transmissions, in accordance with certain aspects of the present disclosure.

FIG. 8 illustrates example resource usage for CAP DL OFDMA transmissions, in accordance with certain aspects of the present disclosure.

FIG. 9 illustrates example power correction measurements, in accordance with certain aspects of the present disclosure.

FIG. 10 provides a side-by-side comparison of example resource allocation phases for CAP multi user (MU) DL OFDMA transmissions and CAP single user (SU) DL OFDMA transmissions, in accordance with certain aspects of the present disclosure

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Certain aspects of the present disclosure provide techniques that may allow multiple access points (APs) to coordinate to send simultaneous OFDMA transmissions to a single user (SU). A set of APs participating in such a coordinated effort may be referred to as a coordinated AP (CAP) set. Hence, the transmissions according to this scheme may be referred to as CAP SU OFDMA transmissions.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

The techniques described herein may be used for various broadband wireless communication systems, including communication systems that are based on an orthogonal multiplexing scheme. Examples of such communication systems include Spatial Division Multiple Access (SDMA), Time Division Multiple Access (TDMA), Orthogonal Frequency Division Multiple Access (OFDMA) systems, Single-Carrier Frequency Division Multiple Access (SC-FDMA) systems, and so forth. An SDMA system may utilize sufficiently different directions to simultaneously transmit data belonging to multiple user terminals. A TDMA system may allow multiple user terminals to share the same frequency channel by dividing the transmission signal into different time slots, each time slot being assigned to different user terminal. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA. The techniques described herein may be utilized in any type of applied to Single Carrier (SC) and SC-MIMO systems.

The teachings herein may be incorporated into (e.g., implemented within or performed by) a variety of wired or wireless apparatuses (e.g., nodes). In some aspects, a wireless node implemented in accordance with the teachings herein may comprise an access point or an access terminal.

An access point (“AP”) may comprise, be implemented as, or known as a Node B, a Radio Network Controller (“RNC”), an evolved Node B (eNB), a Base Station Controller (“BSC”), a Base Transceiver Station (“BTS”), a Base Station (“BS”), a Transceiver Function (“TF”), a Radio Router, a Radio Transceiver, a Basic Service Set (“BSS”), an Extended Service Set (“ESS”), a Radio Base Station (“RBS”), or some other terminology.

An access terminal (“AT”) may comprise, be implemented as, or known as a subscriber station, a subscriber unit, a mobile station, a remote station, a remote terminal, a user terminal, a user agent, a user device, user equipment, a user station, or some other terminology. In some implementations, an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, a Station (“STA”), or some other suitable processing device connected to a wireless modem (such as an AR/VR console and headset). Accordingly, one or more aspects taught herein may be incorporated into a phone (e.g., a cellular phone or smart phone), a computer (e.g., a laptop), a portable communication device, a portable computing device (e.g., a personal data assistant), an entertainment device (e.g., a music or video device, or a satellite radio), a global positioning system device, or any other suitable device that is configured to communicate via a wireless or wired medium. In some aspects, the node is a wireless node. Such wireless node may provide, for example, connectivity for or to a network (e.g., a wide area network such as the Internet or a cellular network) via a wired or wireless communication link.

### Example Wireless Communication System

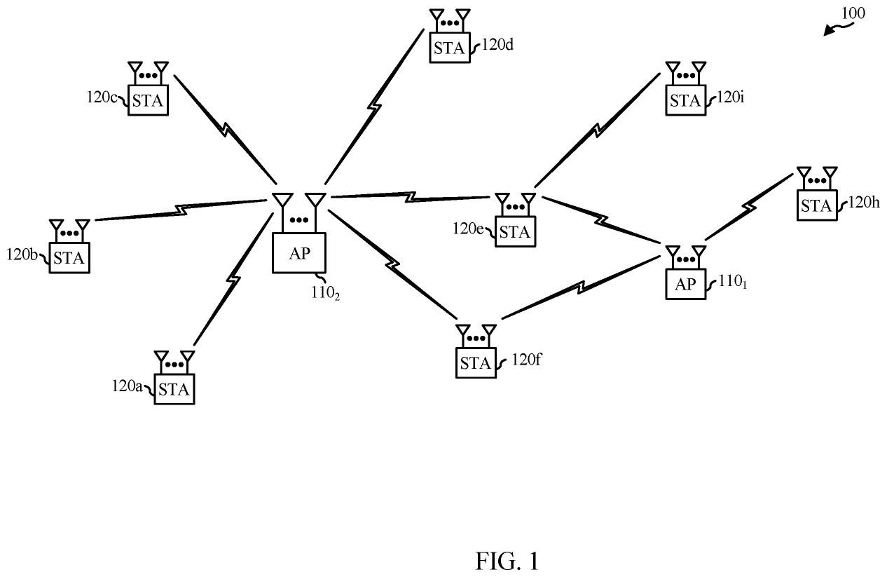

FIG. 1 illustrates a multiple-access multiple-input multiple-output (MIMO) system 100 (e.g., 802.11, LTE, or NR wireless communication systems) with access points (APs) 110 and user terminals (UT) 120, in which aspects of the present disclosure may be practiced. For example, a set of APs 110 (e.g., APs 1101 and 1102) may coordinate to send DL OFDMA transmissions to a single UT 120 in accordance with techniques described herein.

For simplicity, only two access points 110 are shown in FIG. 1. An access point is generally a fixed station that communicates with the user terminals and may also be referred to as a base station or some other terminology. A user terminal may be fixed or mobile and may also be referred to as a mobile station, a wireless device or some other terminology. Access point 110 may communicate with one or more user terminals 120 at any given moment on the downlink and uplink. The downlink (i.e., forward link) is the communication link from the access point to the user terminals, and the uplink (i.e., reverse link) is the communication link from the user terminals to the access point. A user terminal may also communicate peer-to-peer with another user terminal. The term communication generally refers to transmitting, receiving, or both. In the following description, the subscript “dn” denotes the downlink, the subscript “up” denotes the uplink, Nup user terminals are selected for simultaneous transmission on the uplink, Ndn user terminals are selected for simultaneous transmission on the downlink, Nup may or may not be equal to Ndn, and Nup and Ndn may be static values or can change for each scheduling interval. The beam-steering or some other spatial processing technique may be used at the access point and user terminal.

While portions of the following disclosure will describe user terminals 120 capable of communicating via Spatial Division Multiple Access (SDMA), for certain aspects, the user terminals 120 may also include some user terminals that do not support SDMA. Thus, for such aspects, an access point (AP) 110 may be configured to communicate with both SDMA and non-SDMA user terminals. This approach may conveniently allow older versions of user terminals (“legacy” stations) to remain deployed in an enterprise, extending their useful lifetime, while allowing newer SDMA user terminals to be introduced as deemed appropriate.

The system 100 employs multiple transmit and multiple receive antennas for data transmission on the downlink and uplink. The access point 110 is equipped with Nₐₚ antennas and represents the multiple-input (MI) for downlink transmissions and the multiple-output (MO) for uplink transmissions. A set of K selected user terminals 120 collectively represents the multiple-output for downlink transmissions and the multiple-input for uplink transmissions. For pure SDMA, it is desired to have Nₐₚ≥K≥1 if the data symbol streams for the K user terminals are not multiplexed in code, frequency or time by some means. K may be greater than Nₐₚ if the data symbol streams can be multiplexed using TDMA technique, different code channels with CDMA, disjoint sets of subbands with OFDM, and so on. Each selected user terminal transmits user-specific data to and/or receives user-specific data from the access point. In general, each selected user terminal may be equipped with one or multiple antennas (i.e., Nᵤₜ≥1). The K selected user terminals can have the same or different number of antennas.

The system 100 may be a time division duplex (TDD) system or a frequency division duplex (FDD) system. For a TDD system, the downlink and uplink share the same frequency band. For an FDD system, the downlink and uplink use different frequency bands. MIMO system 100 may also utilize a single carrier or multiple carriers for transmission. Each user terminal may be equipped with a single antenna (e.g., in order to keep costs down) or multiple antennas (e.g., where the additional cost can be supported). The system 100 may also be a TDMA system if the user terminals 120 share the same frequency channel by dividing transmission/reception into different time slots, each time slot being assigned to different user terminal 120.

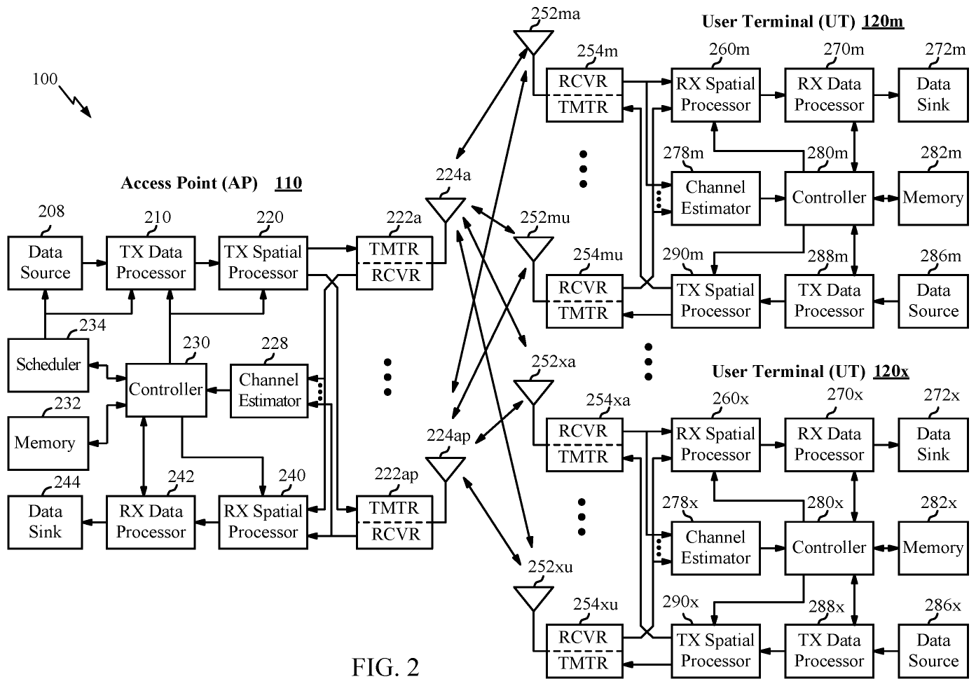

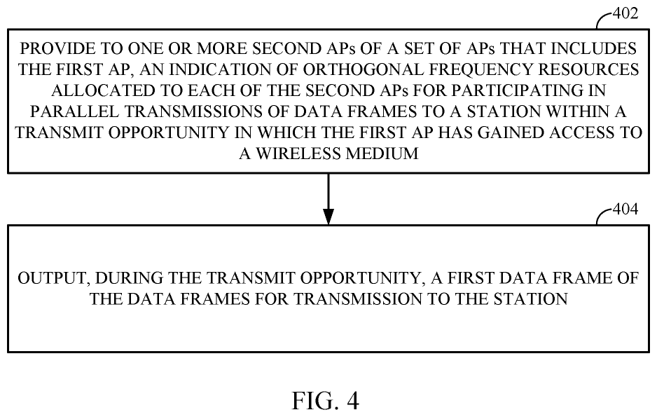

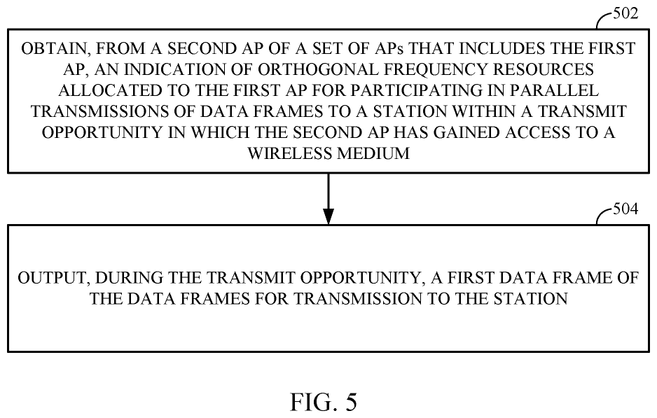

FIG. 2 illustrates a block diagram of access point 110 and two user terminals 120m and 120x in MIMO system 100, which may be used to implement aspects of the present disclosure. For example, antennas 224 and processors 210, 220, 230, 240, 242 of the AP 110 and/or antennas 252 and processors 260, 270, 280, 288, 290 of the UT 120 may be used to perform the various techniques and methods described herein, such as the operations depicted in FIGS. 4, 5 & 6.

The access point 110 is equipped with Nₜ antennas 224a through 224t. User terminal 120m is equipped with N_{ut,m} antennas 252ma through 252mu, and user terminal 120x is equipped with N_{ut,x} antennas 252xa through 252xu. The access point 110 is a transmitting entity for the downlink and a receiving entity for the uplink. Each user terminal 120 is a transmitting entity for the uplink and a receiving entity for the downlink. As used herein, a “transmitting entity” is an independently operated apparatus or device capable of transmitting data via a wireless channel, and a “receiving entity” is an independently operated apparatus or device capable of receiving data via a wireless channel. The term communication generally refers to transmitting, receiving, or both. In the following description, the subscript “dn” denotes the downlink, the subscript “up” denotes the uplink, Nup user terminals are selected for simultaneous transmission on the uplink, Ndn user terminals are selected for simultaneous transmission on the downlink, Nup may or may not be equal to Ndn, and Nup and Ndn may be static values or can change for each scheduling interval. The beam-steering or some other spatial processing technique may be used at the access point and user terminal.

On the uplink, at each user terminal 120 selected for uplink transmission, a TX data processor 288 receives traffic data from a data source 286 and control data from a controller 280. TX data processor 288 processes (e.g., encodes, interleaves, and modulates) the traffic data for the user terminal based on the coding and modulation schemes associated with the rate selected for the user terminal and provides a data symbol stream. A TX spatial processor 290 performs spatial processing on the data symbol stream and provides N_{ut,m} transmit symbol streams for the N_{ut,m} antennas. Each transmitter unit (TMTR) 254 receives and processes (e.g., converts to analog, amplifies, filters, and frequency upconverts) a respective transmit symbol stream to generate an uplink signal. N_{ut,m} transmitter units 254 provide N_{ut,m} uplink signals for transmission from N_{ut,m} antennas 252 to the access point.

Nup user terminals may be scheduled for simultaneous transmission on the uplink. Each of these user terminals performs spatial processing on its data symbol stream and transmits its set of transmit symbol streams on the uplink to the access point.

At access point 110, Nₐₚ antennas 224a through 224ap receive the uplink signals from all Nup user terminals transmitting on the uplink. Each antenna 224 provides a received signal to a respective receiver unit (RCVR) 222. Each receiver unit 222 performs processing complementary to that performed by transmitter unit 254 and provides a received symbol stream. An RX spatial processor 240 performs receiver spatial processing on the Nₐₚ received symbol streams from Nₐₚ receiver units 222 and provides Nup recovered uplink data symbol streams. The receiver spatial processing is performed in accordance with the channel correlation matrix inversion (CCMI), minimum mean square error (MMSE), soft interference cancellation (SIC), or some other technique. Each recovered uplink data symbol stream is an estimate of a data symbol stream transmitted by a respective user terminal. An RX data processor 242 processes (e.g., demodulates, deinterleaves, and decodes) each recovered uplink data symbol stream in accordance with the rate used for that stream to obtain decoded data. The decoded data for each user terminal may be provided to a data sink 244 for storage and/or a controller 230 for further processing.

On the downlink, at access point 110, a TX data processor 210 receives traffic data from a data source 208 for Ndn user terminals scheduled for downlink transmission, control data from a controller 230, and possibly other data from a scheduler 234. The various types of data may be sent on different transport channels. TX data processor 210 processes (e.g., encodes, interleaves, and modulates) the traffic data for each user terminal based on the rate selected for that user terminal. TX data processor 210 provides Ndn downlink data symbol streams for the Ndn user terminals. A TX spatial processor 220 performs spatial processing (such as a precoding or beamforming, as described in the present disclosure) on the Ndn downlink data symbol streams, and provides Nₐₚ transmit symbol streams for the Nₐₚ antennas. Each transmitter unit 222 receives and processes a respective transmit symbol stream to generate a downlink signal. Nₐₚ transmitter units 222 providing Nₐₚ downlink signals for transmission from Nₐₚ antennas 224 to the user terminals.

At each user terminal 120, N_{ut,m} antennas 252 receive the Nₐₚ downlink signals from access point 110. Each receiver unit 254 processes a received signal from an associated antenna 252 and provides a received symbol stream. An RX spatial processor 260 performs receiver spatial processing on N_{ut,m} received symbol streams from N_{ut,m} receiver units 254 and provides a recovered downlink data symbol stream for the user terminal. The receiver spatial processing is performed in accordance with the CCMI, MMSE or some other technique. An RX data processor 270 processes (e.g., demodulates, deinterleaves and decodes) the recovered downlink data symbol stream to obtain decoded data for the user terminal.

At each user terminal 120, a channel estimator 278 estimates the downlink channel response and provides downlink channel estimates, which may include channel gain estimates, SNR estimates, noise variance and so on. Similarly, a channel estimator 228 estimates the uplink channel response and provides uplink channel estimates. Controller 280 for each user terminal typically derives the spatial filter matrix for the user terminal based on the downlink channel response matrix H_{dn,m} for that user terminal. Controller 230 derives the spatial filter matrix for the access point based on the effective uplink channel response matrix H_{up,eff}. Controller 280 for each user terminal may send feedback information (e.g., the downlink and/or uplink eigenvectors, eigenvalues, SNR estimates, and so on) to the access point. Controllers 230 and 280 also control the operation of various processing units at access point 110 and user terminal 120, respectively.

### Example Techniques for Cap Su OFDMA Transmissions

Certain systems (e.g., IEEE 802.11ax networks) may support DL OFDMA transmission within a single BSS, where a single AP can divide frequency resources and transmit to different clients on different frequencies. In some cases (e.g., successors to 802.11 ax), APs from multiple BSSs be able to perform DL OFDMA at the same time in a coordinated fashion to send data to their own clients.

Certain aspects of the present disclosure provide techniques that allow multiple access points (APs) to coordinate to send simultaneous (OFDMA) transmissions to a single user (SU). As will be described in greater detail below, CAP SU OFDMA transmissions may be enabled when a particular AP that has gained (won) access to a wireless medium for a transmit opportunity (TXOP) learns neighbor APs also have data to transmit and frees resources for those other APs to send their data in the same TXOP (on their respective frequency channels).

There are several potential benefits to such a CAP SU OFDMA transmission scheme, with multiple APs serving a single user with transmissions on different frequency resources. These potential benefits include, include an increase in signal to noise ratio (SNR— as each signal is coming on shorter bandwidth portions which reduces noise), an improvement in latency (as a station has more opportunities to be served by different APs), and increased robustness (e.g., as duplicated information may be received from multiple APs on different frequencies providing frequency diversity).

To enable CAP SU OFDMA transmissions, multiple APs with their own basic service sets (BSSs) may form a Coordinated AP Service Set (CAPS S). The member APs may be in wireless range of each other, meaning there may be no need for backhaul coordination, as over-the-air (OTA) coordination may be used instead. A station (STA) may effectively perform association with the CAPSS by associating with any member of the CAPSS. This association makes the STA eligible to transmit and receive (TX/RX) to any AP in the CAPSS.

Data to be sent to a client (that has associated with the CAPSS) may be available at any of the CAPSS member APs. To provide flexibility, there may be no pre-assigned Master AP or pre-assigned AP groups, rather any member AP that owns a TXOP may initiate a CAP SU OFDMA transmission sequence.

CAP OFDMA transmissions (whether MU or SU) may include a resource allocation phase, in which participating APs learn of their allocated subchannels. In some cases, the AP owning the current TXOP (e.g., via explicit scheduling or contention-based with a zero backoff timer) may be responsible for letting participating APs know their allocated subchannels.

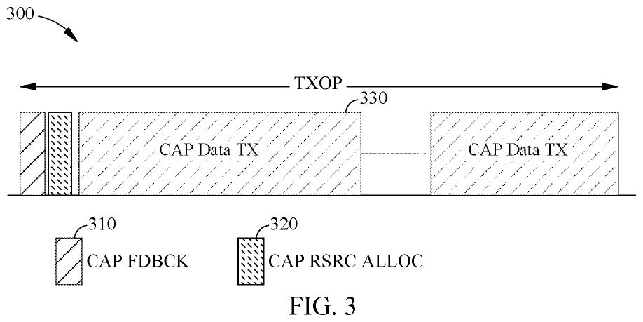

FIG. 3 illustrates an example of a CAP DL OFDMA sequence 300 with a resource allocation phase at a beginning of a TXOP. As illustrated, the sequence may begin with an optional CAP feedback phase 310, during which the TXOP Owner checks availability of potential participating APs (e.g., members of the CAPSS that have data for the station).

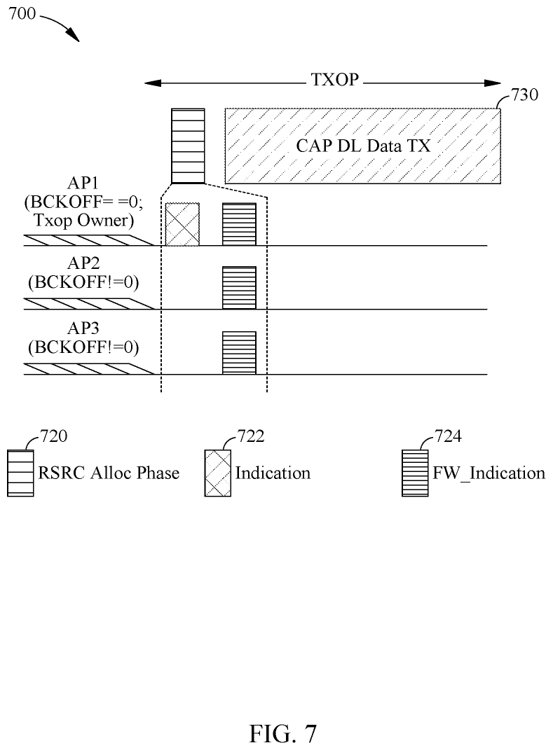

During a resource allocation phase (CAP RSRC Alloc) 320, the TXOP owner may send a frame to tell participating APs of their allocated subchannels. In some cases, the frame may include an AID indicating a destination of the upcoming CAP DL data transmissions. In some cases, the RSRC Alloc frame may also include an indication of whether the upcoming (CAP DL OFDMA) data transmissions are MU or SU. In some cases, the indication may be via a special AID (e.g., a reserved value or range) and/or via an explicit bit (or field). For an MU sequence, the participating APs may then tell their clients the allocated subchannels (and direct them to park on those subchannels in preparation of DL transmissions to follow). As illustrated in FIG. 7, the participating APs may tell their clients (or SU station) of the allocated subchannels via a forward indication (FW_Indication) frame.

After the resource allocation phase, the coordinated access point (CAP) OFDMA data transmissions (CAP Data TX) 330 may occur in the remaining portion of the TXOP. In other words, the TXOP Owner and other participating APs may transmit on RUs (Resource Units) in their respective allocated subchannels.

Operation of the various actors, the TXOP owner, other participating APs, and an SU station, during an CAP DL SU OFDMA sequence, are illustrated in FIGS. 4, 5, and 6.

FIG. 4 illustrates example operations 400 that may be performed by the TXOP owner, in accordance with certain aspects of the present disclosure. For example, operations 400 may be performed by an AP 110 of FIG. 1 that is a member of a CAPSS and has gained access to the medium.

Operations 400 begin, at 402, by providing to one or more second APs (other participating APs that are members of the CAPSS) of a set of APs that includes the first AP, an indication of orthogonal frequency resources allocated to each of the second APs for participating in parallel transmissions of data frames to a station within a transmit opportunity in which the first AP has gained access to a wireless medium. At 404, the access point outputs, during the transmit opportunity, a first data frame of the data frames for transmission to the station.

FIG. 5 illustrates example operations 500 that may be performed by the other participating APs, in accordance with certain aspects of the present disclosure. For example, operations 500 may be performed by one or more APs that are members in a same CAPS S as the TXOP owner performing operations 400.

Operations 500 begin, at 502, by obtaining, from a second AP of a set of APs that includes the first AP, an indication of orthogonal frequency resources allocated to the first AP for participating in parallel transmissions of data frames to a station within a transmit opportunity in which the second AP has gained access to a wireless medium. At 504, the access point outputs, during the transmit opportunity, a first data frame of the data frames for transmission to the station

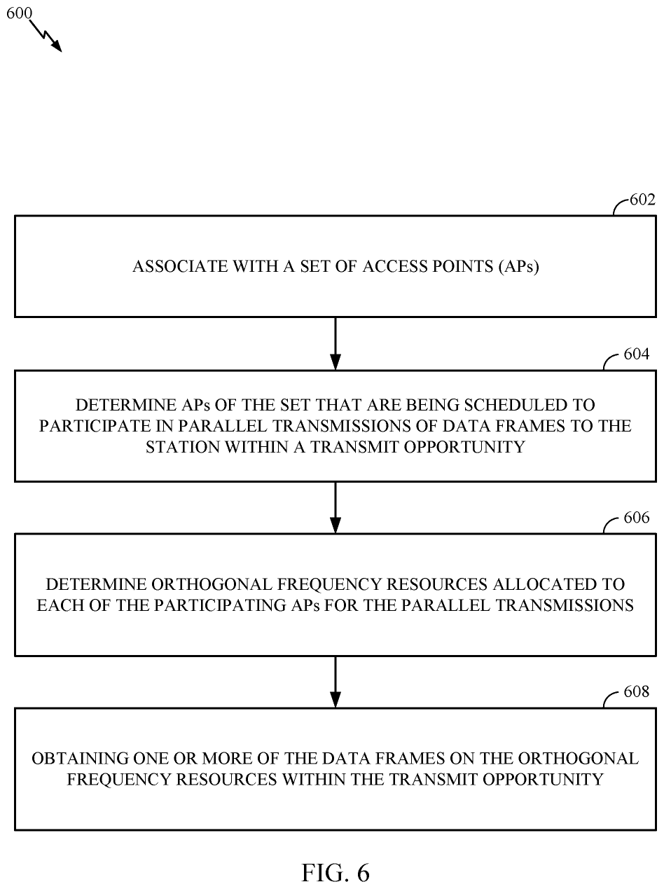

FIG. 6 illustrates example operations 600 that may be performed by a station (STA), in accordance with certain aspects of the present disclosure. For example, operations 600 may be performed by a STA that has associated with any member of the CAPSS (and thereby associated with the CAPSS).

Operations 600 begin, at 602, by the access point associating with a set of access points (APs). At 604, the station determines APs of the set that are being scheduled to participate in parallel transmissions of data frames to the station within a transmit opportunity. At 606, the station determines orthogonal frequency resources allocated to each of the participating APs for the parallel transmissions. At 608, the station obtains one or more of the data frames on the orthogonal frequency resources within the transmit opportunity.

The operations described above may be understood with reference to FIG. 7, which illustrates a CAP DL SU OFDMA sequence 700, assuming a CAPSS with three APs (AP1, AP2, and AP3, with AP1 owning the TXOP). While the example is described with reference to CAP DL SU OFDMA, this same sequence may also be used for CAP DL SU OFDMA transmissions (e.g., with the TXOP owner providing an indication of MU or SU via an AID or explicit bit as described above).

As illustrated in FIG. 7, during the resource allocation phase 720, AP1 sends an indication frame 722 to tell the other participating APs (AP2 and AP3) of their allocated subchannels. As illustrated, each participating may then send an indication (FW_Indication) 724 to tell their clients (or the same SU client) of their allocated subchannels for the upcoming CAP DL data transmissions 730. In some cases, the indication frame may be a trigger frame variant (and sent in a non high throughput duplicate “non-HT DUP” in basic service set bandwidth “BSS BW”) and may carry common and per-BSS Information fields and the AID of the intended target of the data transmission to follow). In some cases, the indication may be an MU frame sent in a Primary channel only or over the BSS BW (and may leverage a SIGB preamble field).

As illustrated, the TXOP Owner may also send a Trigger frame at the start of the CAP Data Tx Phase. In some cases, the trigger frame may be used for timing and frequency correction purposes. For example, the data transmissions may occur a fixed spacing after the end of the trigger frame and/or the trigger frame may include training frames allowing for frequency corrections.

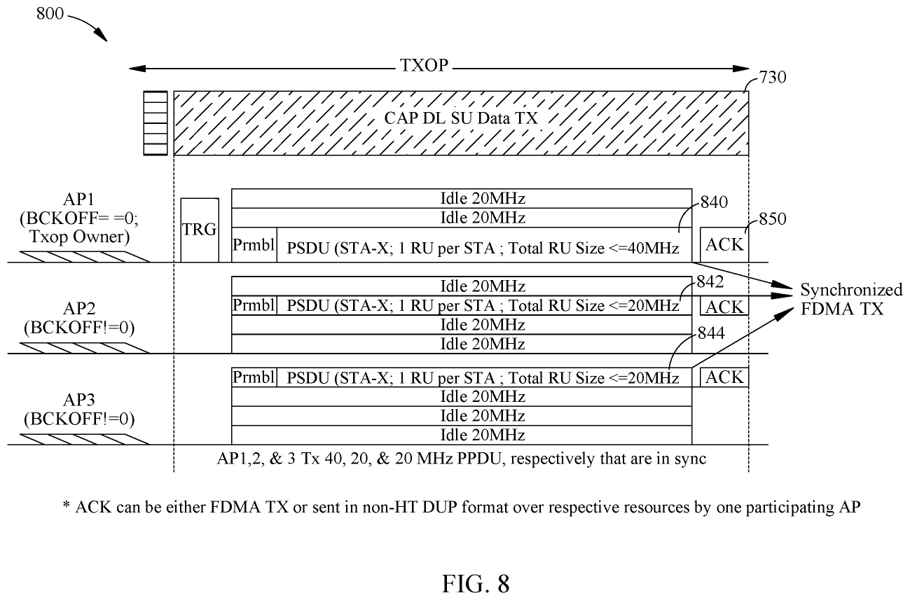

FIG. 8 provides an example sequence 800 that demonstrates how the different participating APs may use different subchannels for their transmission to the SU station. In the illustrated example, AP1 transmits on a 40 MHz channel 840, while AP2 and AP3 simultaneously transmit on (separate) 20 MHz channels (842 and 844, respectively).

As illustrated, the STA may provide acknowledgment feedback (ACK) to each participating AP. In this example, the STA provides an individual ACK 850 to each AP same subchannel that was used for the data Tx from that AP. In other cases, the AP may send a wideband ACK, for example, that spans all the subchannels used in the CAP DL data transmissions (e.g., 40 MHz+20 MHz+20 MHz=80 MHz in this case).

In some cases, adjustments to transmit power (Power Pre-Correction) may be applied for CAP DL SU transmissions. For example, the TXOP Owner and other participating APs may adjust transmit power to control interference between the parallel transmissions. These adjustments may be analogous to adjustments made for power control in other applications (e.g., by an HE AP for UL TB PPDU).

In some cases, to determine what adjustment to apply to the transmit power, the TXOP Owner may send a frame to solicit a response transmission from the SU client (STA). For example, the TXOP owner may send a request to send (RTS or multicast RTS or “mRTS”) frame upon winning the channel and before start of CAP DL OFDMA TX sequence. The client responds with a CTS that is heard by TXOP Owner and neighboring APs and each measures and notes the received power of the CTS from Client.

As described above with reference to FIG. 8, the TXOP Owner may also send a Trigger frame at the start of the CAP Data Tx Phase. In some cases, this trigger frame may carry information that provides guidance to the other participating APs to perform power pre-correction. For example, this information may include the Tx Power of the TXOP Owner, a target signal to interference ratio (SIR) at the Client, and/or Received power of the CTS at the TXOP Owner. Given this information, a participating AP can calculate a suitable Tx Power level for its own transmissions.

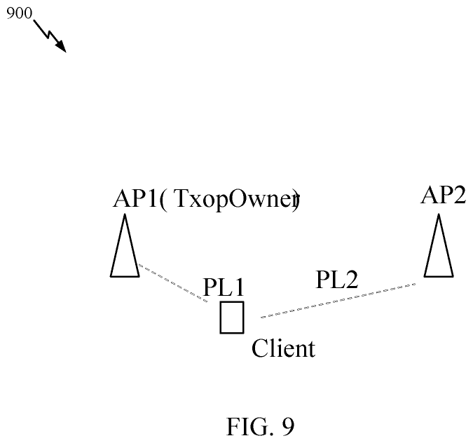

Example power guidance computations may be performed based on the following equations. The measurements indicated in the following equations refer to simple model shown in FIG. 9 that shows an example diagram 900 the TXOP Owner (AP1), AP2, and the client (SU STA). First off, the SIR at the client may be defined as:

SIR=(T₁−PL₁)−(T₂−PL₂)

such that the TXOP owner (AP1) may know the SIR required to serve the Client (where T₁ is the transmit power at AP1, T₂ is the transmit power at AP2, PL₁ is the path loss between AP1 and the STA, and PL₂ is the path loss between AP2 and the STA). Given the SIR, AP2 transmission power required to meet this target SIR may be calculated as:

T₂=(T₁−SIR)+(PL₂−PL₁)

As noted above, both AP1 and AP2 measure the receive (Rx) Power of the CTS sent by the client, these measurements are denoted as:
C1: Rx power of CTS from client measured at AP1
C2: Rx power of CTS from client measured at AP2 with the following relationship:

C₁−C₂=(T_{C}−PL₁)−(T_{c}−PL₂)=PL₂−PL₁

Hence, AP 2 can determine its transmit power based on the information provided by AP1 (T1, C1, and SIR) and its own calculation of C2 as:

T₂=(T₁−SIR)+(C₁−C₂)

As noted above, the TXOP Owner may advertise this information (its own Tx power T1, the target SIR at the client, and C1) in the trigger frame in Data Tx Phase.

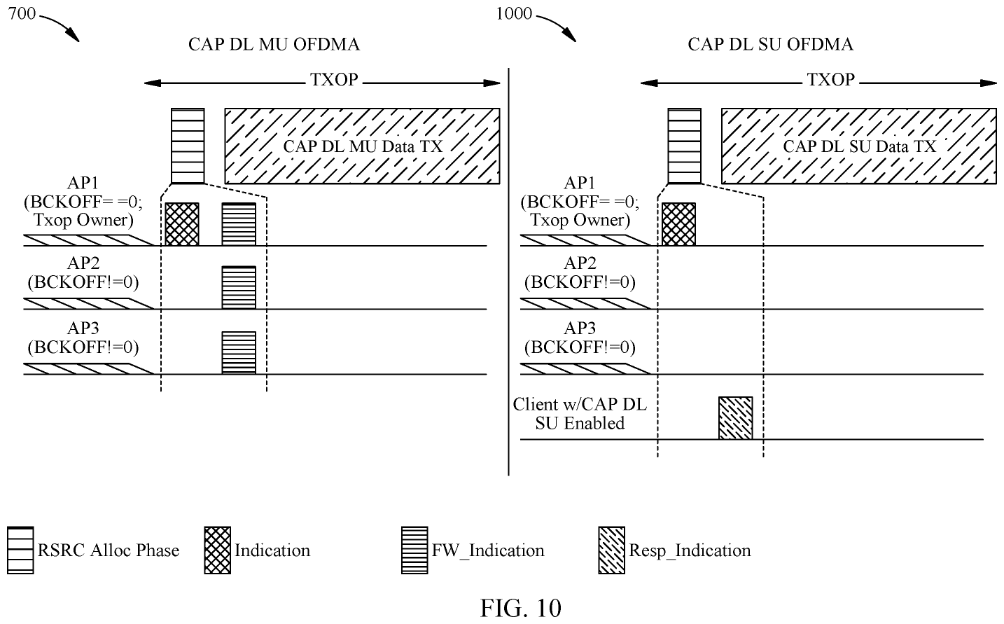

As noted above, in some cases, the same sequence 700 (shown in FIG. 7) may be used for both CAP DL SU and MU OFDMA transmissions. In other cases, as illustrated in FIG. 10, a different sequence 1000 may be used for CAP DL SU OFDMA transmissions.

In this case, for the SU case, the TXOP Owner may still be responsible for telling participating APs their allocated subchannels and the AID may be the destination of the upcoming CAP DL SU Data TX. As noted above, whether the upcoming is CAP DL OFDMA is MU or SU may still be indicated via a special AID or explicit bit(s).

If the indication is for CAP DL MU OFDMA (rather than SU), the participating APs may tell their clients allocated subchannels for Data Tx. If the indication is for CAP DL SU OFDMA (rather than MU), the SU client may determine the participating APs and their allocated subchannels.

In this case, however, rather than the TXOP owner and other participating APs determining their own Tx power pre-correction guidance information, the client may give power pre-correction guidance to the participating APs. For example, the client STA may provide an indication of its target RSSI (or SIR) and its Tx power.

Given this information, the TXOP owner and other participating APs may perform Tx power adjustments to control interference b/w parallel transmissions. For example, the APs may determine transmit power based on the following equations:

TxPwr_{AP}=Rssi_{Target}+PL, where PL=TxPwr_{STA}−Rssi_{AP}

where TxPwr_{AP} is the Participating AP transmit power for CAP DL SU TX, Rssi_{Target} is the expected RX signal strength by STA on a RU, TxPwr_{STA} is the STA transmit power of a response to the indication frame sent by the TXOP owner (Resp_Indication), and Rssi_{AP} is the Rx signal strength at AP of the Resp_Indication.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, a phrase referring to “at least one of” a list of items refers to any combination of those items, including single members. As an example, “at least one of: a, b, or c” is intended to cover a, b, c, a-b, a-c, b-c, and a-b-c, as well as combinations that include multiples of one or more members (aa, bb, and/or cc).

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

Means for receiving or means for obtaining may include a receiver (such as the receiver unit 222) or an antenna(s) 224 of the access point 110 or the receiver unit 254 or antenna(s) 252 of the station 120 illustrated in FIG. 2. Means for transmitting or means for outputting may include a transmitter (such as the transmitter unit 222) or an antenna(s) 224 of the access point 110 or the transmitter unit 254 or antenna(s) 252 of the station 120 illustrated in FIG. 2. Means for associating, means for determining, means for monitoring, means for deciding, means for providing, means for detecting, means for performing, and/or means for setting may include a processing system, which may include one or more processors, such as the RX data processor 242, the TX data processor 210, the TX spatial processor 220, RX spatial processor 240, or the controller 230 of the access point 110 or the RX data processor 270, the TX data processor 288, the TX spatial processor 290, RX spatial processor 260, or the controller 280 of the station 120 illustrated in FIG. 2.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception.

The functions described may be implemented in hardware, software, firmware, or any combination thereof. If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the wireless node, all which may be accessed by the processor through the bus interface. Alternatively, or in addition, the machine-readable media, or any portion thereof, may be integrated into the processor, such as the case may be with cache and/or general register files.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may be implemented with an ASIC (Application Specific Integrated Circuit) with the processor, the bus interface, the user interface in the case of an access terminal), supporting circuitry, and at least a portion of the machine-readable media integrated into a single chip, or with one or more FPGAs (Field Programmable Gate Arrays), PLDs (Programmable Logic Devices), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. An apparatus for wireless communications by a station, comprising:
a processing system configured to:
associate with a set of access points (APs);
determine APs of the set that are being scheduled to participate in parallel transmissions of data frames to the station within a transmit opportunity; and
determine orthogonal frequency resources allocated to each of the participating APs for the parallel transmissions; and
an interface configured to obtain one or more of the data frames on the orthogonal frequency resources within the transmit opportunity.

2. The apparatus of claim 1, wherein the processing system is further configured to provide an indication to at least one of the set of APs that the station has enabled or disabled capability to obtain data frames on the orthogonal frequency resources or wherein the orthogonal frequency resources allocated to each of the participating APs are determined based on indications, from the participating APs.

3. The apparatus of claim 1, wherein:
the interface is further configured to obtain, from an AP of the set that has gained access to a wireless medium for the transmit opportunity, an indication that the data frames target the same station; and
the processing system is further configured to monitor the orthogonal frequency resources for the data frames based on the indication.

4. The apparatus of claim 3, wherein the indication comprises at least one of:
a bit or field that explicitly indicates the data frames target the same station; or
an association identifier (AID) that indicates the data frames target the same station.

5. The apparatus of claim 1, wherein the processing system is further configured to provide an acknowledgment of the data frames obtained by the station and further wherein:
the acknowledgment of the data frames is provided via separate acknowledgments using the orthogonal frequency resources allocated to each of the participating APs; or
the acknowledgment of the data frames is provided as a single acknowledgment via a bandwidth that spans the orthogonal frequency resources allocated to each of the participating APs.

6. The apparatus of claim 1, wherein the interface is further configured to:
obtain a first frame from an AP of the set that has gained access to a wireless medium for the transmit opportunity; and
output a second frame for transmission after obtaining the first frame.

7. The apparatus of claim 1, wherein the processing system is further configured to:
provide information to the participating APs for use in setting power of their parallel transmissions and further wherein the information comprises at least one of a target receive signal strength or a transmit power of the station.

8. The apparatus of claim 1, further comprising a receiver configured to receive the one or more of the data frames on the orthogonal frequency resources within the transmit opportunity, wherein the apparatus is configured as the station.

9. An apparatus for wireless communications by a first access point (AP), comprising:
a processing system configured to provide to one or more second APs of a set of APs that includes the first AP, an indication of orthogonal frequency resources allocated to each of the second APs for participating in parallel transmissions of data frames to a station within a transmit opportunity in which the first AP has gained access to a wireless medium; and
an interface configured to output, during the transmit opportunity, a first data frame of the data frames for transmission to the station.

10. The apparatus of claim 9, wherein:
the interface is further configured to obtain a second indication that the station has enabled or disabled capability to obtain data frames on the orthogonal frequency resources and the processing system is further configured to decide whether to participate in parallel transmissions of subsequent data frames to the station based on the second indication; or
the interface is further configured to:
output a first frame for transmission to the station, after the first AP has gained access to the medium; and
obtain a second frame from the station; and
the processing systems is further configured to:
determine a received power of the second frame at the first AP; and
set a transmit power for transmission of the first data frame based, at least in part, on the received power of the second frame at the first AP.

11. The apparatus of claim 9, wherein the interface is further configured to output, for transmission, a second indication that the data frames target the same station and further wherein the second indication comprises at least one of:
a bit or field that explicitly indicates the data frames target the same station; or
an association identifier (AID) that indicates the data frames target the same station.

12. The apparatus of claim 9, wherein the interface is further configured to obtain, from the station, an acknowledgment of the first data frame.

13. The apparatus of claim 12, wherein the acknowledgment is obtained by using orthogonal frequency resources allocated to the first AP for the first data frame.

14. The apparatus of claim 12, wherein the acknowledgment is obtained via a bandwidth that spans the orthogonal frequency resources allocated to the first AP and each of the second APs participating in the parallel transmissions of the data frames to the station.

15. The apparatus of claim 9, wherein the processing system is further configured to provide information to the second APs for use in setting power of their parallel data transmissions to the station.

16. The apparatus of claim 15, wherein the information comprises at least one of: a target received signal metric of the station, a transmit power of a first frame output for transmission by the first AP, or a received power of a second frame obtained by the first AP from the station.

17. The apparatus of claim 15, wherein the information is provided via a trigger frame.

18. The apparatus of claim 9, wherein the interface is further configured to obtain information from the station for use in setting the transmit power for transmission of the first data frame and further wherein the information comprises at least one of a target received signal strength metric of the station or a transmit power of the station.

19. The apparatus of claim 9, further comprising a transmitter configured to transmit, during the transmit opportunity, the first data frame of the data frames to the station, wherein the apparatus is configured as the first access point.

20. An apparatus for wireless communications by a first access point (AP), comprising:
a processing system configured to generate a first data frame; and
an interface configured to:
obtain, from a second AP of a set of APs that includes the first AP, an indication of orthogonal frequency resources allocated to the first AP for participating in parallel transmissions of data frames to a station within a transmit opportunity in which the second AP has gained access to a wireless medium; and
output, during the transmit opportunity, the first data frame of the data frames for transmission to the station.

21. The apparatus of claim 20, wherein:
the interface is further configured to obtain a second indication that the station has enabled or disabled capability to obtain data frames on the orthogonal frequency resources and the processing system is further configured to decide whether to participate in parallel transmissions of subsequent data frames to the station based on the second indication; or
the processing system is further configured to:
detect a first frame from the second AP;
detect, after detecting the first frame, a second frame from the station;
determine a received power of the second frame at the first AP; and
set a transmit power for the first data frame based, at least in part, on the received power of the second frame at the first AP.

22. The apparatus of claim 20, wherein the interface is further configured to:
obtain, from the second AP, a second indication that the data frames target the same station; and
output the first data frame based on the second indication.

23. The apparatus of claim 22, wherein the second indication comprises at least one of:
a bit or field that explicitly indicates the data frames target the same station; or
an association identifier (AID) that indicates the data frames target the same station.

24. The apparatus of claim 20, wherein the interface is further configured to obtain, from the station, an acknowledgment of the first data frame and further wherein:
the acknowledgment is obtained by using orthogonal frequency resources allocated to the first AP for the first data frame; or
the acknowledgment is obtained via a bandwidth that spans the orthogonal frequency resources allocated to each AP participating in the parallel transmissions of the data frames to the station.

25. The apparatus of claim 20, wherein:
the interface is further configured to obtain information from the second AP for use in setting the transmit power of the first data frame; and
the processing system is further configured to set a transmit power for the first data frame based, at least in part, on the information.

26. The apparatus of claim 25, wherein the information comprises at least one of: a target received signal strength of the station, a transmit power of a first frame sent by the second AP, or a received power of a second frame at the second AP.

27. The apparatus of claim 25, wherein the information is obtained via a trigger frame.

28. The apparatus of claim 20, wherein the interface is further configured to:
obtain information from the station for use in setting a transmit power of the first data frame and further wherein the information comprises at least one of a target received signal strength of the station or a transmit power of the station.

29. The apparatus of claim 20 further comprising a transceiver configured to receive the indication and transmit the first data frame of the data frames to the station, wherein the apparatus is configured as the first access point.

30. A method for wireless communications by a station, comprising:
associating with a set of access points (APs);
determining APs of the set that are being scheduled to participate in parallel transmissions of data frames to the station within a transmit opportunity;
determining orthogonal frequency resources allocated to each of the participating APs for the parallel transmissions; and
obtaining one or more of the data frames on the orthogonal frequency resources within the transmit opportunity.
